(19) United States
(12) Patent Application Publication
(10) Pub. No.: US 2011/0081452 A1
(43) Pub. Date: Apr. 7, 2011

(54) PRODUCTION OF LIVE INSECT "MINI-LARVAE" AND USE THEREOF FOR FEEDING AQUARIUM FISH, ALEVINS OF FARM FISH AND PETS

(75) Inventors: Saurin Hem, Montpellier (FR); Melta Rini Fahmi, Depok (ID)

(73) Assignee: INSTITUT DE RECHERCHE POUR DEVELOPPOEMENT (I.R.D.), Marseille Cedex 02 (FR)

(21) Appl. No.: 12/988,208

(22) PCT Filed: Apr. 7, 2009
(86) PCT No.: PCT/FR2009/050592

§ 371 Date: Dec. 6, 2010

(30) Foreign Application Priority Data
Apr. 16, 2008 (FR) 0802096

(51) Int. Cl. A23K 1/18; A01K 29/00

(52) U.S. Cl. 426/61; 119/6.6

(57) ABSTRACT

Method for obtaining insect larvae kept alive and use thereof as food for fish with an oral orifice having a diameter of between 1.2 and 4 mm, in particular aquarium fish and alevins of farmed species, and also for pets.

This invention relates to the production and use of living insect <<mini-larvae>> for feeding aquarium fish, cultivated fish fry and as bait or feed for domestic or laboratory animal like rodents (mouse, rat . . . ), lizard and bird.

During the last decades ornamental fish-keeping has become more and more popular, and the public at large have become highly infatuated with aquariums which are constantly enriched with various animal species, as maintained in ever more complex artificial ecosystems, ever nearer to the natural environment conditions which were those of these animal species.

It has now become rare to see a large town without a public aquarium, this being clearly a preferred educational place for discovery, accessible to all, and very often offered for study to scientists who can thus easily study various aquatic animal species. Given this, and in the present context where environmental preoccupations become more and more marked, these aquariums now become very important tools to help in understanding, defending and preserving marine and aquatic environments.

On the other hand, the increased scarcity of some marine or fresh water fish species, having for decades been extensively fished, raises important ecological and economic questions, now leading to the development of ever more numerous and sophisticated fish farms and rearing installations.

The simultaneous development of ornamental fish-keeping and fish farming markets generates a growing demand for fish feed, this naturally having to diversify and follow demand. At the time being this feed is usually marketed as meals, granules or flakes which are preserved in sterile packages and are normally formulated in order to be able to satisfy the nutritional needs of fish in captivity.

It seems however that this feed has some disadvantages. More specifically it has been observed that some fish species flatly refuse to eat it, or cannot absorb it because of the grain size, which is too coarse. The food then accumulates in the raceways, where it contributes in a high degree to the lowering of the quality of the water. Apart from its negative consequences for the growth and development of fish and fry, this situation entails more maintenance work in aquariums and raceways, and this, while generating constraints, also produces noticeable cost overruns. Moreover the supply of this type of feed no longer suffices to satisfy a growing demand, and prices have been observed to grow sharply.

One notes a gradual development of the market for feed comprising living preys, such as Chironomidae or <<bloodworm>> (Diptera) larvae, micro-worms (nematodes), earthworms, etc . . . , taken to be more natural and much more attractive for fish. However the disadvantage entailed by the use of this kind of feed resides in pathogenic germ dissemination hazards in aquariums and rearing raceways—these germs being carried by the feed.

Pet like small rodents, lizard and bird also need feed free from pathogenic germ and which is easy to ingest. Insect larvae are largely used, especially those of Hermetia illucens.

Now the inventor has surprisingly observed that it is possible to obtain small larvae (i.e. <<mini-larvae>>) with a morphology which is quite identical to that of normal size larvae, and with identical weight input/output ratio as to biomass.

The aim of the invention is to provide a method for the production of living insect mini-larvae, making an attractive feed for fish and fry, notably for the smaller ones and also for pet. These living preys, taken to be healthy and without any pathogenic germs, are ideally absorbed by the fish, laboratory or domestic animal and therefore prevent any wasting, water pollution and consequential financial loss.

The term <<mini-larvae>> refers to insect living larvae whose body diameter does not exceed 4 mm, even 3 mm and length does not exceed 10 mm.

The phrase <<the smaller ones>> refers to fish and fry whose mouth diameter does not exceed 4 mm.

The phrase <<living preys>> refers to the living organisms which are to feed the fish, and which must:

create a good appetence for the fish,

possess the necessary nutritional qualities,

be easily available and ready to satisfy market demands,

be mass produced according to techniques which may be industrialized and economically profitable,

possess physiological characteristics which enable them to survive under preservation conditions without any loss of nutritional quality,

be preserved in a simple manner (e.g. room temperature or refrigerator),

not have unpleasant odors,

be clean and not bear pathogenic germs.

Thus the aim of the invention is the use of a culture medium comprising a mixture of water, cereals and/or oil cakes and possibly a fermentation agent which is added for the incubation of insect eggs in order to obtain living preserved larvae with a maximum body diameter between 1-4 mm, notably ca. 2 mm and with a maximum body length between 4-12 mm, especially between 5-12, especially between 4-8 mm, notably 9mm, notably 6 mm, being maintained approximately constant during at least 4 weeks, notably 6 weeks.

In an advantageous embodiment of the invention the culture medium cereals and/or oil cakes undergo a fermentation step in the dark or in free air during 1 week at a temperature between 27-40° C., notably 27-32° C.

In another advantageous embodiment of the invention the water/cereals or water/oil cakes weight ratio is between 1-3, notably 1-2.2 and is preferably 2.

In still another advantageous embodiment of the invention, la proportion the water/cereals +oil cakes ratio is between 1-3, preferably 2.

According to the invention the fermentation agent which is added is present at a rate of 0-2 weight % in relation to the cereals and/or oil cakes dry weight.

In a particularly advantageous embodiment the inventive culture medium comprises oil cakes and is totally devoid of any added fermentation agent.

According to the invention the fermentation agent is chosen from among bacteria, microscopic fungi, notably yeasts ; the culture medium cereals are chosen from among wheat, spelt, maize, barley, winter barley, rice, millet, rye, sorghum and oats. Oats is particularly used, and the culture medium oil cakes are chosen from among soy, peanut, rape, sunflower, flax, grape pip, olive, copra and palm kernel oil cakes, the palm kernel oil cake being particularly used.

The invention also relates to a composition comprising:

a culture medium containing a mixture of water, cereals and/or oil cakes and possibly fermentation agent, and,

insect eggs and/or larvae which have been incubated in said culture medium.

In an advantageous embodiment of the invention the composition comprises incubated insect eggs at a rate of 0.5-1.5 g/kg culture medium, notably 1 g/kg culture medium.

Advantageously insect larvae as contained in the inventive composition have a maximum body diameter between 1-4 mm, notably 2 mm, and a maximum body length between 5-12, notably between 4-8 mm, notably 9 mm, notably 6 mm.

In an advantageous embodiment of the invention the composition comprises Hermetia illucens eggs. Indeed it has been observed that Hermetia illucens mini-larvae as obtained with the inventive method satisfy the whole set of above-mentioned criteria.

When palm kernel oil cake is used as culture medium for Hermetia illucens, the ratio between the quantity of insect eggs and the quantity of culture medium is equal to 500, advantageously equal to 1000, more advantageously equal to 1500 and still more advantageously equal to 2000.

Another aim of the invention is a method for obtaining living preserved insect larvae whose maximum diameter, between 1-4 mm, notably ca. 2 mm, and whose maximum body length, between 5-12, notably between 4-8 mm, notably 9 mm, notably 6 mm, are kept approximately constant during at least 4 weeks, notably 6 weeks, said method comprising the following steps :

1) incubation of insect eggs in a culture medium comprising a mixture of water, cereals and/or oil cakes, and, possibly, a fermentation agent, said incubation being carried out until the eggs are hatched and the larvae are obtained, in order to obtain an inventive composition,

2) dehydration of said composition until a water content below 15% (weight/weight), advantageously 10% (weight/weight) is obtained,

3) collection, from said composition, of living insect larvae, with a maximum body diameter between 1-4 mm, notably ca. 2 mm, and a maximum body length between 5 −12, notably between 4-8 mm, notably 9 mm, notably 6 mm and,

4) transfer of said living larvae as collected in a feedless environment where they are maintained alive in the dark during at least 4 weeks, notably 6 weeks, under 60-80% relative humidity and at a temperature between 12-18° C., notably 15° C.

According to an advantageous embodiment of the invention the mass production of mini-larvae, as living preys, is carried out from fertilized eggs, in a closed and controlled space wherein the insects are reared and protected. This method allows one a perfect monitoring of the growth and development of larvae, and is therefore best adapted to the mass production of mini-larvae. The chosen insect populations are confined in a cage which isolates them totally from the outside environment and protects them from predation by other insects or by animals such as rodents, reptiles, batrachians or birds. Only insects belonging to the species as chosen for rearing and production of mini-larvae may breed within this cage, which is arranged in such a manner that it reproduces as nearly as possible the natural habitat of insects which are kept there.

In an advantageous embodiment of the invention insect rearing applies to animals belonging to the holometabolic group, particularly Hermetia illucens. This insect is reared within a cage in an atmosphere whose relative humidity and temperature are maintained, respectively, between 70-80% and 27-30° C. Advantageously plants belonging to Sphagneticola sp fill the cage and foster the development of Hermetia illucens insects.

Insect pupae are placed inside the cage in plastic exuviation trays (ca. 5,000-10,000 pupae per plastic tray). After 2-5 weeks and after exuviation (i.e. imago moulting yielding the imago), the first adult insects appear, and, after staying still during 1-2 hours, they fly into the cage in order to get feed and to breed.

According to a particularly advantageous aspect of the invention, the selected pupae are Hermetia illucens pupae which, after exuviation, feed on honey dilutions in water. One week after exuviation males and females can mate. One week after mating, the female Hermetia illucens lays between 400-1 200 eggs.

Insect eggs are preferentially laid in artificial crevices which are specially created to that effect in the immediate vicinity of a culture medium.

According to a preferred aspect of the invention the term <<artificial crevices>> denotes the folds and gatherings as generated around the opening of a plastic bag, of the <<bottomless waste bag>> type, equipped with built-in closing straps, when these straps are pulled in order to partly close said bag when it has been placed near the culture medium.

According to an advantageous aspect of the invention, the preferential laying at said artificial crevices allows one to collect large amounts of insect eggs rapidly and easily. One only has to collect said plastic bags, to ungather the folds and open the gatherings to liberate the large amounts of eggs they contained, and which may then easily be collected.

The phrase <<large amounts of eggs>> denotes crops which, every 3 days and for the whole of the cage, may reach 15-20 g egg biomass, and considering that 1 g of such a biomass contains ca. 38,000-40,000 insect eggs.

In an advantageous embodiment of the inventive method, the insect egg incubation and hatching step in the culture medium is carried out during 1-3 days, notably 2 days, at a temperature between 24-35° C., notably 27-32° C., ideally 29° C.

Under natural fertilizing conditions, insect eggs, when laid onto a culture medium comprising a mixture of dry palm kernel oil cakes and water (1/2 ; weight/weight), known to attract females, give birth, 21 days later, to larvae.

In a remarkable manner the inventor has been able to show that these mini-larvae result from a diapause phenomenon, which is caused by: (1) a dehydration of the culture medium on which they develop, and (2) a feeding deficiency resulting from a larval overpopulation.

The word <<diapause>> describes a slow-moving form of life and a survival reaction from larvae when placed under hostile environmental conditions. This diapause allows one to stop growth and to maintain the larvae in their basal metabolism before being marketed.

The word << dehydration>> means that the culture medium has a gradually lower water content, until it comprises no more than 15% water (weight/weight), ideally 10% water (weight/weight).

In an advantageous embodiment of the invention the living larvae are maintained, before the dehydration step, at a temperature between 24-35° C., notably between 27-32° C., advantageously 29° C., during 3-6 days after hatching of the insect eggs, notably 4 days.

An another aim of the invention is also the use of insect larvae as obtained according to the inventive method for the preparation of feed for aquarium fish or pet like small rodents, lizard and bird. The insect larvae obtained according to the process of the invention are particularly suitable for the preparation of feed for fry and fish with a mouth opening having a diameter between 1.2-4 mm, notably 2-3 mm.

The insect <<mini-larvae>> as obtained by the inventive method possess excellent nutritional qualities and are very attractive. These mini-larvae are larvae whose sizes are homogeneous, and which may be classified according to a body diameter calibration system (1.5 mm ; 2.0 mm ; 3.0 mm-4.0 mm) Production of the minilarvae according to these 4 calibration systems is ensured by adjusting the proportions between the amount of eggs which are cultivated (mass in milligrams) and the amount of fermented oil cakes which is made available.

The fish and fry fed with the inventive mini-larvae undergo a much quicker weight growth than when fed with other kinds of living preys as may be found on the market.

The invention will be better understood with the help of Examples 1-7 herebelow, which describe the production methods and the use of living insect mini-larvae for feeding aquarium fishes and raised fish fry.

### Example 1—Preparation Of A Culture Medium Based On Palm Kernel Oil Cakes For The Incubation Of Hermetia Illucens Eggs And Larvae

In order to attract Hermetia illucens females onto a preferential hatching place, and to incubate the thus obtained eggs as well as Hermetia illucens larvae, a culture medium is carefully prepared in the following manner:

with a coffee mill 1 kg palm kernel oil cake is ground until a very fine powder is obtained,

this palm kernel oil cake powder is mixed with 2 kg (or 2 litres) water until a kind of perfectly homogeneous palm kernel oil cake purée is obtained,

the whole is left to ferment in the dark or at free air, at a temperature between 25-30° C. during one week.

At the end a kind of perfectly homogeneous thus fermented palm kernel oil cake purée is ready for use as a culture medium for Hermetia illucens eggs and larvae.

### Example 2—Oats-Based Culture Medium For The Incubation Of Hermetia Illucens Eggs And Larvae

In order to attract Hermetia illucens females onto a preferential hatching place, and to incubate the thus obtained eggs as well as Hermetia illucens larvae, a culture medium is carefully prepared in the following manner:

with a coffee mill 1 kg oats is ground until a very fine powder is obtained,

this oats powder is mixed with 2 kg (or 2 litres) water until a kind of perfectly homogeneous oats purée is obtained,

one per cent yeast (weight/weight in relation to the oats dry weight) is added to this kind of perfectly homogeneous oats purée, and the whole is carefully mixed,

the whole is left to ferment in the dark or in free air, at a temperature between 25-30° C. during one week.

In the end the kind of perfectly homogeneous thus fermented oats purée is ready to be used as a culture medium for Hermetia illucens eggs and larvae.

### Example 3—Production Of Hermetia Illucens Eggs

In a specially designed cage where they were born from 1 kg biomass from the pupae which had been put into equally specially designed plastic trays, Hermetia illucens males and females may freely mate, and hatchings occur between 1-3 weeks later.

Everyday plastic bags of the <<bottomless waste bags>> type, equipped with built-in closing straps and filled with a culture medium according to Examples 1 or 2 are partially closed by pulling the closing straps in order to create, around the opening of said plastic bags, folds and gatherings forming between them crevices wherein Hermetia illucens females, being attracted by the culture medium, come to lay eggs preferentially.

Every 3 days 15-20 g Hermetia illucens eggs are thus carefully collected by cautiously opening said plastic bags.

In order to avoid any weighing error the eggs must be collected in a very clean fashion, without debris, and without being accompanied with an excess of water or damp.

### Example 4—Production Of Hermetia Illucens Mini-Larvae Having A Body Diameter Of Ca. 1.5-2 mm And A Length Of Ca. 6 mm

In order to obtain mini-larvae with a body diameter of ca. 1.5-2 mm and a length of ca. 6 mm, 1 g Hermetia illucens eggs as obtained on the same day according to Example 3 are incubated with 500 g culture medium, such as prepared in Examples 1 or 2, and spread in a 3 −5 cm layer at the bottom of fiberglass culture trays. Three days later hatchings are observed.

Five days after the eggs have hatched and the larvae have appeared a ventilation of the culture medium is carried out in order to allow it to be gradually dehydrated until it reaches, 2 days later, a water content of ca. 10% (weight/weight). Under such dehydration conditions, 10 days after the eggs have been fertilized on the culture medium, the larval growth is stopped at a given maturity stage.

The thus-obtained mini-larvae are carefully cleaned (without any water), using a brush, and placed in diapause (i.e. a slowed down form of life allowing the organism to adapt to hostile environmental conditions), in the dark, in a thermoregulated cabinet at a temperature of 15° C. and under a relative humidity of 70%.

Under such conditions the mini-larvae may be kept alive during 4-6 weeks and be used as living preys to feed aquarium fishes and rearing fish fry.

According to needs the state of diapause may be interrupted and the mini-larvae may be replaced in the culture medium, where their growth and development may resume until they reach a larger size, from which they will again be able to be put in diapause, or even reach their normal size.

### Example 5—Production Of Hermetia Illucens Mini-Larvae Having A Body Diameter Of Ca. 3-4 mm And A Length Of Ca. 6.2 mm

In order to obtain mini-larvae with a body diameter of ca. 2.5-3 mm and a length of ca. 10 mm, 2 g Hermetia illucens eggs as obtained on the same day according to Example 3 are incubated with 2 kg culture medium, such as prepared in Examples 1 or 2 and spread in a 3-5 cm thick layer at the bottom of fiberglass cultivation trays. Three days later the first hatchings were observed.

Ten days after egg hatching and appearance of larvae a ventilation of the culture medium is carried out, allowing it to be gradually dehydrated until it reaches, 2 days later, a water content of ca. 10% (weight/weight). Under such dehydration conditions, 10 days after the eggs have been fertilized on the culture medium, larval growth is stopped at the desired maturity stage.

The thus obtained mini-larvae are carefully cleaned (without any water) with a brush and placed in diapause (i.e. a slowed down form of life allowing the organism to adapt to hostile environmental conditions), in the dark, in a thermoregulated cabinet at a temperature of 15° C. and under a relative humidity of 70%.

Under such conditions, the mini-larvae may be maintained alive during 4-6 weeks, and be used as living preys for feeding the fish and fry.

According to needs, the state of diapause may be interrupted, and the mini-larvae may be replaced in the culture medium, where their growth and development may resume until they reach a larger size, from which they will again be able to be put in diapause, or even reach their normal size.

### Example 6—Effects Of The Availability Of The Culture Medium On The Ending Of Growth Of Mini-Larvae Of The Insect Hermetia Illucens

Breedings conditions are the same as in example 1 except that the ratio between the masses of eggs and the quantity of culture medium is varied from 500(1 g of eggs for 500 g culture medium) to 2000 (1 g of eggs for 2 kg of culture medium).
Results concerning the mean length, the mean body diameter and the mean weight are given in the following tables 1 A to 1C

TABLE 1
A

| | |
|---|---|
| | Mean body lenght (mm) |
| Culture duration | Ratio mass of eggs/culture medium |

| (day) | 500X | 1000X | 1500X | 2000X |
|---|---|---|---|---|
| J7 | 5.58 | 5.99 | 7.52 | 10.19 |
| J14 | 6.19 | 8.91 | 12.10 | 16.28 |
| J21 | 5.92 | 9.23 | 13.08 | 18.05 |

B

| | |
|---|---|
| | Mean body diameter (mm) |
| Culture duration | Ratio mass of eggs/culture medium |

| (day) | 500X | 1000X | 1500X | 2000X |
|---|---|---|---|---|
| J7 | 1.5 | 1.59 | 2.08 | 3.29 |
| J14 | 1.59 | 2.24 | 3.02 | 4.31 |
| J21 | 1.87 | 2.38 | 3.26 | 4.54 |

C

| | |
|---|---|
| | Mean weight (mg) |
| Culture duration | Ratio mass of eggs/culture medium |

| (day) | 500X | 1000X | 1500X | 2000X |
|---|---|---|---|---|
| J7 | 8.99 | 10.23 | 24.63 | 44.33 |
| J14 | 9.61 | 21.73 | 51.72 | 117.28 |
| J21 | 7.44 | 20.89 | 58.84 | 128.80 |

### Example 7—Nutritional Value And Importance Of Hermetia Illucens Mini-Larvae In Relation To Other Living Preys Which May Make Up The Feed For The Fish

Tests have been carried out in order to demonstrate the nutritional quality and benefits of mini-larvae in relation to other living preys which may be used for feeding fishes, notably aquarium fishes and fish farm fry having an oral diameter between 1.2-3 mm, notably between 1.8-2 mm.

Chromobotia macracanthus (Cobitidae family), also called <<Botia>>, is an ornamental fish which is very much in demand with amateurs. At present the supply in this species on the ornamental fish market comes from solely from fish captured in a natural environment (Sumatra-Kalimantan).

As this species is now becoming extinct, a method for breeding Botia in captivity has now been developed. However this still raises some difficulties as feeding the young Botia is said to be very difficult with inert conventional food, whether meal, granules or flakes. This fish, as well as the fry, preferably feed on living preys. For the very young stages (under one month), weaning is carried out with Artemia nauplii. For more advanced stages, viz. between 1-3 months, one used cut earthworms or blood worms. The latter are Chironome insect larvae as collected from river sludge, or at the bottom of ponds or backwaters.

However the use of these living preys raises a hygiene and sanitary problem inasmuch as they are very often carriers of pathogenic germs which may infect the fish and fry. One must therefore look for other types of living preys which do not have this disadvantage and which possess at least the same nutritive qualities as earthworms or bloodworms.

During a period of 70 days mini-larvae as produced according to Example 4 having a body diameter of ca. 1.5 mm and a length of ca. 6 mm and cut earthworms or bloodworms have been offered, under quite identical conditions, to 2 months old Botia fry weighing ca. 0.23 g.

During this 70 days period it has been observed that the growth and development of fry fed with Hermetia illucens mini-larvae is 1.2 times more rapid than with those fed with bloodworms, and twice as rapid as with those fed with cut earthworms.

1-21. (canceled)

22. A method for obtaining insect larvae which are kept alive, with a maximum diameter between 1-4 mm, notably ca. 2 mm, and whose maximum body lengths, between 4-12, notably between 5-12, notably between 4-8 mm, notably 9 mm, notably 6 mm, are maintained approximately constant during at least 4 weeks, notably 6 weeks, said method comprising the following steps :
1) incubation of insect eggs in a culture medium comprising a mixture of water, cereals and/or oil cakes, and possibly a fermentation agent, said incubation being carried out until the eggs are hatched and larvae are obtained, in order to obtain a composition comprising a culture medium, said medium comprising a mixture of water, cereals and/or oil cakes, and possibly a fermentation agent, and insect eggs and/or larvae which have been incubated in said culture medium.
2) dehydration of said composition until a water content below 15% (weight/weight), ideally 10% (weight/weight) is obtained,
3) collection, from said composition, of living insect larvae, with a maximum body diameter between 1-4 mm, notably ca. 2 mm, and a maximum body length between 5-12, notably between 4-8 mm, notably 9 mm, notably 6 mm, and,
4) transfer of said living larvae as collected in an environment without feed, where they are maintained alive, in the dark, during at least 4 weeks, notably 6 weeks, under a relative humidity between 60-80% and at a temperature between 12-18° C., notably 15° C.

23. A method according to claim 22, wherein the eggs of insect are obtained from insect populations confined in a cage which isolates them totally from the outside environment and protects them from predation by other insects or by animals, said cage being arranged in such a manner that it reproduces as nearly as possible the natural habitat of insects which are kept there.

24. A method according to claim 22, wherein the insects belong to the holometabolic group, in particular Hermetia illucens, reared within a cage in an atmosphere whose relative humidity and temperature are maintained, respectively, between 70-80% and 27-30° C., advantageously in presence of plants belonging to Sphagneticola sp.

25. A method according to claim 22, wherein insect pupae are placed inside the cage in plastic exuviation trays containing ca. 5,000-10,000 pupae per plastic tray.

26. A method according to claim 22, wherein insect eggs are laid in artificial crevices which are specially created to that effect in the immediate vicinity of a culture medium.

27. A method according to claim 22, wherein the cereals and/or oil cakes undergo a fermentation, in the dark or in free air, during 1 week and at a temperature between 27-40° C., notably between 27-32° C.

28. A method according to claim 22, wherein the water/cereals or water/oil cakes weight ratio in the culture medium is between 1-3, notably 1-2.2 and preferably 2.

29. A method according to claim 22, wherein the water/cereals+oil cakes weight ratio is between 1-3, preferably 2.

30. A method according to claim 22, wherein the culture medium comprises a fermentation agent which is added at a rate of between 0-2 weight% in relation to the cereals and/or oil cakes dry weight.

31. A method according to claim 22, wherein the culture medium includes oil cakes, and is totally devoid of any added fermentation agent.

32. A method according to claim 22, wherein the culture medium includes a fermentation agent which is chosen from among bacteria and microscopic fungi as chosen within the group comprising yeasts.

33. A method according to claim 22, wherein the culture medium comprises cereals, said cereals being chosen from among wheat, spelt, maize, barley, winter barley, rice, millet, rye, sorghum and oats.

34. A method according to claim 22, wherein the culture medium comprises oil cakes, said oil cakes being chosen from among soy, groundnuts, rape, sunflower, flax, grape pip, olive, sorgho and palm kernel oil cakes.

35. A method according to claim 22, wherein the insect egg incubation and hatching step in the culture medium is carried out during 1-3 days, notably 2 days, at a temperature between 24-35° C., notably between 27-32° C., ideally 29° C.

36. A method according to claim 22, wherein the living larvae are maintained, before the dehydration step, at a temperature between 24-35° C., notably between 27-32° C., ideally 29° C., during 3-6 days after insect egg hatching, notably 4 days.

37. Aquarium fish and domestic animal feed comprising insect larvae as obtained according to claim 22.

38. Method of using insect larvae obtained by the method according to claim 22, for the preparation of a feed for fry and fishes with an oral diameter between 1.2-4 mm, notably between 2-3 mm.

39. Composition comprising a culture medium which includes a mixture of water, cereals and/or oil cakes, and possibly a fermentation agent, insect eggs and/or larvae which have been incubated in said culture medium, wherein the cereals and/or the oil cakes have undergone a fermentation, in the dark or in free air, during 1 week and at a temperature of 27-40° C., notably 27-32° C.

40. Composition according to claim 39 comprising insect eggs which have been incubated at a rate of 0.5-1.5 g/kg culture medium, notably 1 g/kg culture medium.

41. Composition according to claim 39, comprising insect larvae with a maximum body diameter between 1-4 mm, notably 2 mm, and a maximum body length between 4-12, notably between 5-12, notably between 4-8 mm, notably 9 mm, notably 6 mm.

42. Composition according to claim 39, wherein the eggs and/or larvae have been obtained from Hermetia illucens.
